(19) United States
(12) Patent Application Publication
(10) Pub. No.: US 2009/0249272 A1
(43) Pub. Date: Oct. 1, 2009

(54) STATISTICAL TIMING ANALYZER AND STATISTICAL TIMING ANALYSIS METHOD

(75) Inventor: Tomoyuki Yoda, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/400,819

(22) Filed: Mar. 10, 2009

(30) Foreign Application Priority Data
Mar. 31, 2008 (JP) 2008-093253

(51) Int. Cl. G06F 17/50

(52) U.S. Cl. 716/6

(57) ABSTRACT

A statistical timing analyzer comprises a statistical static-timing analyzing unit that performs a statistical static timing analysis of a semiconductor integrated circuit; a corner-condition determining unit that determines corner conditions of the semiconductor integrated circuit based on a result of the statistical static timing analysis; and a path-timing analyzing unit that performs a static timing analysis of the semiconductor integrated circuit based on the corner conditions.

### CROSS-REFERENCE TO RELATED APPLICATIONS

This application is based upon and claims the benefit of priority from the prior Japanese Patent Application No. 2008-093253, filed on Mar. 31, 2008; the entire contents of which are incorporated herein by reference.

### BACKGROUND OF THE INVENTION

1. Field of the Invention

The present invention relates to a statistical timing analyzer and a statistical timing analysis method, and, more particularly to a statistical timing analyzer and a statistical timing analysis method that are suitable for application to a method of analyzing delay variations in a semiconductor integrated circuit, caused by variations in process conditions or operation environments.

2. Description of the Related Art

With recent downsizing of the semiconductor integrated circuit, the delay variation in the semiconductor integrated circuit, caused by variations in the process conditions or operation environments, has become great. To ensure the operation of the semiconductor integrated circuit having the fluctuating delay, the delay variation is examined by a static timing analysis.

In the static timing analysis, the delay variation is commonly treated as corners. That is, when variation due to a certain factor is to be examined, the static timing analysis is performed in two cases: one in which the variation factor has a minimum value, and one in which the variation factor has a maximum value. Accordingly, the circuit operation performed when the variation factor varies from the minimum value to the maximum value is ensured.

However, in the method of treating the delay variation as corners, time required to execute the static timing analysis becomes considerably long when the number of variation factors becomes large. That is, when there are plural variation factors, the static timing analysis needs to be performed at combinations of minimum and maximum values of all the variation factors. Therefore, when the number of variation factors is n, 2ⁿ times of the static timing analysis need to be performed by the number of all paths, and consequently this method is impractical when there are many variation factors.

U.S. Pat. No. 7,181,713 discloses a method of first performing a static timing analysis at a smaller number of corners (usually, two corners of best and worst conditions), then extracting a subset of the circuit whose timing is critical in a result of the analysis, and performing the static timing analysis at all corners for the subset of the circuit.

In the method disclosed in the U.S. Pat. No. 7,181,713, however, a second static timing analysis needs to be performed at all corners for the subset of the circuit that is extracted by the first static timing analysis. Therefore, the analysis time is short when the subset of the circuit extracted by the first static timing analysis is small, while the analysis time is adversely long when the subset of the circuit extracted by the first static timing analysis is large. A common circuit usually has more than thousands of critical paths, and the method disclosed in U.S. Pat. No. 7,181,713 does not enable to perform the static timing analysis for such a circuit in a sufficiently short analysis time.

Japanese Patent Application Laid-open No. 2005-92885 discloses a method of expressing variation factors of delay in a semiconductor integrated circuit as random variables, and further expressing the delay as a linear sum of the random variables, thereby performing a statistical static timing analysis. The method disclosed in Japanese Patent Application Laid-open No. 2005-92885 enables to realize the static timing analysis in consideration of variation by a single statistical static timing analysis without a corner analysis.

In the method disclosed in Japanese Patent Application Laid-open No. 2005-92885, however, the variation factor treated as a range cannot be considered throughout the range, and therefore the analysis accuracy is deteriorated. Examples of the variation factor treated as a range are a supply voltage and a temperature at which the operation of the circuit is ensured. The variation factor treated as a range has minimum and maximum values, and the circuit operation within the range needs to be ensured. For example, when there are two variation factors treated as a range, i.e., a voltage and a temperature, the range of the variation factors are rectangular, while a range analyzed by the statistical static timing analysis is circular. Therefore, an analysis of a condition in which the voltage and the temperature both have the maximum values is not achieved by the statistical static timing analysis.

### BRIEF SUMMARY OF THE INVENTION

A statistical timing analyzer according to an embodiment of the present invention comprises: a statistical static-timing analyzing unit that performs a statistical static timing analysis of a semiconductor integrated circuit; a corner-condition determining unit that determines corner conditions of the semiconductor integrated circuit based on a result of the statistical static timing analysis; and a path-timing analyzing unit that performs a static timing analysis of the semiconductor integrated circuit based on the corner conditions.

A statistical timing analysis method according to an embodiment of the present invention comprises: calculating a statistical slack for which n (n is an integer equal to or larger than 2) variation factors are statistically considered, based on a statistical static timing analysis of a semiconductor integrated circuit; determining corner conditions of the semiconductor integrated circuit based on the statistical slack; and calculating slacks of the semiconductor integrated circuit based on a static timing analysis in the corner conditions.

A statistical timing analysis method according to an embodiment of the present invention comprises: calculating a statistical slack for which n (n is an integer equal to or larger than 2) variation factors are statistically considered, based on a statistical static timing analysis of a semiconductor integrated circuit; selecting critical paths of the semiconductor integrated circuit based on the statistical slack; determining corner conditions of the critical paths based on the statistical slack; and calculating slacks of the semiconductor integrated circuit based on a static timing analysis in the corner conditions.

### BRIEF DESCRIPTION OF THE DRAWINGS

FIG. 1 is a block diagram of a general configuration of a statistical timing analyzer according to a first embodiment of the present invention;

FIG. 2 depicts a difference between a range in which a circuit operation is ensured, and a range to be subjected to a statistical static timing analysis;

FIG. 3 is a flowchart of a timing analyzing process performed by the statistical timing analyzer shown in FIG. 1;

FIG. 4 is a block diagram of a general configuration of a statistical timing analyzer according to a second embodiment of the present invention;

FIG. 5 is a block diagram of a specific configuration of a corner-analyzing delay-calculation library shown in FIG. 4;

FIG. 6 is a flowchart of a timing analyzing process performed by the statistical timing analyzer shown in FIG. 4;

FIG. 7A is a graph of a relation between a slack calculated by a center-analyzing delay-calculation library shown in FIG. 1 and an actual slack;

FIG. 7B is a graph of a relation between a slack calculated by the corner-analyzing delay-calculation library shown in FIG. 4 and an actual slack;

FIG. 8 is a block diagram of a general configuration of a statistical timing analyzer according to a third embodiment of the present invention;

FIG. 9 is a flowchart of a timing analyzing process performed by the statistical timing analyzer shown in FIG. 8;

FIG. 10 is an example of the number of paths counted at each corner condition;

FIG. 11 is a graph of relations between the number of paths in each corner condition and calculation times required for timing analyses;

FIG. 12 is a block diagram of a general configuration of a statistical timing analyzer according to a fourth embodiment of the present invention;

FIG. 13 is a flowchart of a timing analyzing process performed by the statistical timing analyzer shown in FIG. 12;

FIG. 14 is a block diagram of a general configuration of a statistical timing analyzer according to a fifth embodiment of the present invention; and

FIG. 15 is a flowchart of a timing analyzing process performed by the statistical timing analyzer shown in FIG. 14.

### DETAILED DESCRIPTION OF THE INVENTION

Exemplary embodiments of a statistical timing analyzer according to the present invention will be explained below in detail with reference to the accompanying drawings.

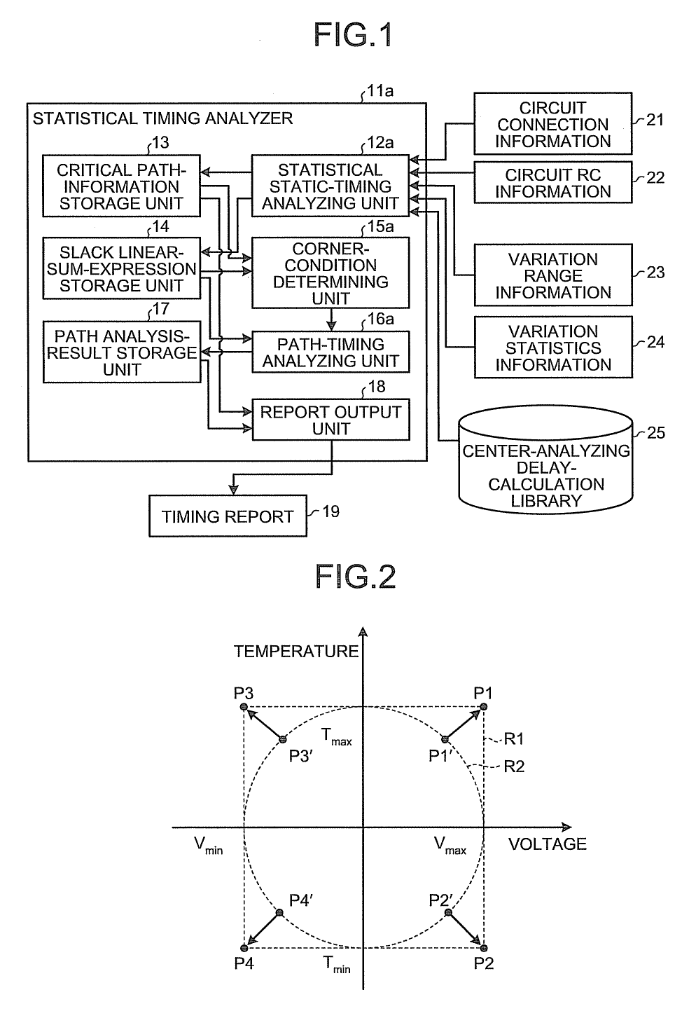

FIG. 1 is a block diagram of a general configuration of a statistical timing analyzer according to a first embodiment of the present invention.

With reference to FIG. 1, a statistical timing analyzer 11a includes a statistical static-timing analyzing unit 12a, a critical path-information storage unit 13, a slack linear-sum-expression storage unit 14, a corner-condition determining unit 15a, a path-timing analyzing unit 16a, a path analysis-result storage unit 17, and a report output unit 18.

The statistical static-timing analyzing unit 12a calculates a linear sum expression of slacks as a statistical slack for which n (n is an integer equal to or larger than 2) variation factors are statistically considered, based on a statistical static timing analysis of a semiconductor integrated circuit. The critical path-information storage unit 13 stores therein information of a critical path selected by the statistical static-timing analyzing unit 12a. The slack linear-sum-expression storage unit 14 stores therein the linear sum expression of slacks calculated by the statistical static-timing analyzing unit 12a. The corner-condition determining unit 15a determines corner conditions of the critical path based on the slack linear sum expression stored in the slack linear-sum-expression storage unit 14. The path-timing analyzing unit 16a calculates slacks of the critical path based on a static timing analysis in the corner conditions determined by the corner-condition determining unit 15a. The path analysis-result storage unit 17 stores therein the slacks of the critical path, calculated by the path-timing analyzing unit 16a. The report output unit 18 outputs the information of the critical paths stored in the critical path-information storage unit 13, and the slacks of the critical paths stored in the path analysis-result storage unit 17, as a timing report 19.

The slack is used as an index of a timing margin complying with or not complying with timing requirements of a digital circuit mounted on the semiconductor integrated circuit. A positive slack indicates a timing margin that complies with the requirements, and a negative slack indicates a timing margin that does not comply with the requirements.

A statistical slack s using a slack linear sum expression can be expressed by following Formula (1).

$$s = {s}_{0} + {\sum }_{i = 1}^{m} {s}_{i} Δ {X}_{i} + {\sum }_{i = m + 1}^{n} {s}_{i} Δ {X}_{i} + {s}_{n + 1} {R}_{d} \qquad ( 1 )$$

where s₀ denotes an average of the slacks, ΔXᵢ denotes a shift amount from an average of variation factors Xᵢ, sᵢ denotes slack sensitivity with respect to the variation factor Xᵢ, Sₙ₊₁ denotes slack sensitivity with respect to a random variation factor other than the variation factor Xᵢ, and R_{d} denotes a coefficient of the sensitivity Sₙ₊₁. It is assumed that, among the variation factors Xᵢ, variation factors X₁ to Xₘ are treated as a range, and variation factors Xₘ₊₁ to Xₙ are treated statistically. The random variation factor indicates variation in a chip, and the variation factor treated statistically indicates variation in a channel width of a transistor or thickness of a gate oxide, for example.

The slack linear-sum-expression storage unit 14 can store therein the average s₀ of the slacks, the slack sensitivity sᵢ with respect to the variation factor Xᵢ, and the slack sensitivity Sₙ₊₁ with respect to the random variation factor other than the variation factor Xᵢ.

The information of the critical paths enables to uniquely identify the critical paths, and can include names of all pins that are passed through by the critical paths and transition directions of a signal passing through the pins, for example.

The timing report 19 can describe the slack of each path, and include the average of the slacks, a variation amount thereof, and the like.

Circuit connection information 21, circuit RC information 22, variation range information 23, variation statistics information 24, and a center-analyzing delay-calculation library 25 are inputted to the statistical static-timing analyzing unit 12a.

The circuit connection information 21 indicates a circuit connection relation, and can be described in a description language such as a Verilog hardware description language (HDL) or a very high speed integrated circuit HDL (VHDL). The circuit RC information 22 indicates resistance or capacitance of wiring in the circuit, and can be described in a format such as a standard parasitic exchange format (SPEF) or a detailed standard parasitic format (DSPF). The variation range information 23 indicates variation information that cannot be treated as statistics, such as a range of a voltage or temperature at which the operation of the circuit is ensured. The variation range information 23 can include three types of information of a variation factor name, a minimum value, and a maximum value of each variation factor. The variation statistics information 24 indicates variation information that can be treated as statistics, such as variation occurring during a manufacturing process. The variation statistic information 24 can include three types of information of a variation factor name, an average, and a standard deviation of the variation factor. The center-analyzing delay-calculation library 25 is used during a statistical static timing analysis to calculate delay of an element, and can be formed of a look-up table that enables to obtain a delay value based on a signal transition time of an element input waveform and an element output capacitance, for example.

The delay value d obtained by the center-analyzing delay-calculation library 25 includes an average, and a variation value of the delay, and can be expressed by following Formula (2), for example.

$$d = {d}_{0} + {\sum }_{i = 1}^{n} {d}_{i} Δ {X}_{i} + {d}_{n + 1} {R}_{d} \qquad ( 2 )$$

where d₀ denotes an average of the delay, ΔXᵢ denotes the shift amount from the average of the variation factor Xᵢ, dᵢ denotes delay sensitivity to the variation factor Xᵢ, and dₙ₊₁ denotes delay sensitivity to a random variation factor other than the variation factor Xᵢ. The center-analyzing delay-calculation library 25 can hold the delay average d₀, the delay sensitivity dᵢ to the variation factor Xᵢ, and the delay sensitivity dₙ₊₁ to the random variation factor other than the variation factor Xᵢ.

The statistical static-timing analyzing unit 12a performs the statistical static timing analysis by referring to the circuit connection information 21, the circuit RC information 22, the variation range information 23, the variation statistics information 24, and the center-analyzing delay-calculation library 25, to obtain a critical path of the circuit, and a slack linear sum expression of the critical path. The information of the critical path is stored in the critical path-information storage unit 13, and the slack linear sum expression of the critical path is stored in the slack linear-sum-expression storage unit 14.

The corner-condition determining unit 15a reads the slack linear sum expression of the critical path obtained by the statistical static-timing analyzing unit 12a, from the slack linear-sum-expression storage unit 14. The corner-condition determining unit 15a then determines a corner condition of the critical path, and outputs the corner condition to the path-timing analyzing unit 16a. In the corner condition determination, the shift amount ΔXᵢ of the variation factor Xᵢ treated as a range is determined to minimize the slack s indicated by Formula (1).

The path-timing analyzing unit 16a reads the slack linear sum expression of the critical path from the slack linear-sum-expression storage unit 14. The path-timing analyzing unit 16a then performs the static timing analysis with respect to the critical path based on the corner condition outputted from the corner-condition determining unit 15a, to calculate the slack of the critical path, and stores the calculated slack in the path analysis-result storage unit 17. The report output unit 18 reads the information of the critical paths stored in the critical path-information storage unit 13 and the slacks of the critical paths stored in the path analysis-result storage unit 17, to output the timing report 19.

FIG. 2 depicts a difference between a range in which the circuit operation is ensured, and a range to be subjected to the statistical static timing analysis.

In FIG. 2, there are two variation factors to be treated as a range, i.e., the voltage and the temperature. Variation of the voltage includes minimum and maximum values Vₘᵢₙ and Vₘₐₓ, and variation of the temperature includes minimum and maximum values Tₘᵢₙ and Tₘₐₓ. A range between the minimum value Vₘᵢₙ and the maximum value Vₘₐₓ of the voltage, and between the minimum value Tₘᵢₙ and the maximum value Tₘₐₓ of the temperature is assumed as a range in which the circuit operation is ensured.

On the other hand, the range to be subjected to the statistical static timing analysis has a circular shape passing through the minimum and maximum values Vₘᵢₙ and Vₘₐₓ of the voltage, and the minimum and maximum values Tₘᵢₙ and Tₘₐₓ of the temperature. It implies that a point P1 at which the voltage and the temperature are both the maximum, a point P2 at which the voltage is the maximum and the temperature is the minimum, a point P3 at which the voltage is the minimum and the temperature is the maximum, and a point P4 at which the voltage and the temperature are both the minimum are not analyzed in the statistical static timing analysis, for example.

Meanwhile, the statistical static-timing analyzing unit 12a shown in FIG. 1 can output statistical slacks of critical paths at points P1′ to P4′ of the voltage and the temperature, for example, by a single statistical static timing analysis. The corner-condition determining unit 15a determines corner conditions of the critical paths to minimize the statistical slacks, thereby obtaining the points P1 to P4 as the corner conditions of the critical paths at the points P1′ to P4′, respectively.

The path-timing analyzing unit 16a can calculate the slack of the critical path selected by the statistical static timing analysis, based on the static timing analysis in the corner conditions of the points P1 to P4.

Accordingly, the corner conditions in the static timing analysis can be determined by the statistical static timing analysis, and the corner conditions in the static timing analysis can be narrowed down by the single statistical static timing analysis. Therefore, even when there are many variation factors, the variation factors treated as a range can be considered throughout the range while increase in the execution time of the timing analysis is suppressed. Accordingly, the timing analysis can be performed accurately even when the downsizing of the semiconductor integrated circuit is progressed.

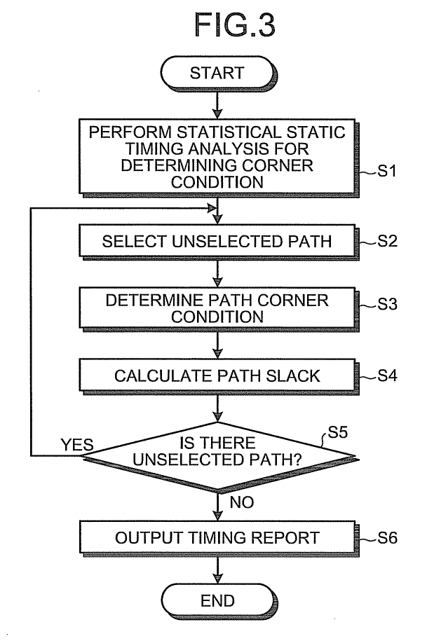

FIG. 3 is a flowchart of a timing analyzing process performed by the statistical timing analyzer shown in FIG. 1.

With reference to FIG. 3, the statistical static-timing analyzing unit 12a in FIG. 1 performs the statistical static timing analysis by referring to the circuit connection information 21, the circuit RC information 22, the variation range information 23, the variation statistics information 24, and the center-analyzing delay-calculation library 25 at Step S1. The statistical static-timing analyzing unit 12a stores resultant information of critical paths in the critical path-information storage unit 13, and stores the slack linear sum expression indicated by Formula (1) in the slack linear-sum-expression storage unit 14.

The corner-condition determining unit 15a in FIG. 1 selects one unselected critical path from among the critical paths stored in the critical path-information storage unit 13 at Step S2. The corner-condition determining unit 15a then determines values ΔX₁, . . . , ΔXₘ in Formula (1) as the corner conditions based on the slack linear sum expression of the selected critical path, at Step S3. The values ΔX₁, . . . , ΔXₘ can be easily determined from a sign of the sensitivity sᵢ of Formula (1). That is, when the sensitivity sᵢ is positive, the slack s becomes smaller as ΔXᵢ is smaller, and thus ΔXᵢ that provides the minimum slack has the minimum value Xᵢ_{_{—}}ₘᵢₙ in the range of Xᵢ. When sᵢ is negative, the slack s becomes smaller as ΔXᵢ is larger, and thus ΔXᵢ that provides the minimum slack has the maximum value Xᵢ_{_{—}}ₘₐₓ in the range of Xᵢ.

At Step S4, the path-timing analyzing unit 16a in FIG. 1 calculates the slacks of the critical path in the corner conditions determined by the corner-condition determining unit 15a. When the value of Xi obtained at Step S3 is X_{icorner}, the slack can be expressed by following Formula (3).

$$s = {s}_{0} + {\sum }_{i = 1}^{m} {s}_{i} {X}_{icorner} + {\sum }_{i = m + 1}^{n} {s}_{i} Δ {X}_{i} + {s}_{n + 1} {R}_{d} \qquad ( 3 )$$

where X_{icorner}=Xᵢ_{_{—}}ₘᵢₙ when the sensitivity sᵢ is positive, and X_{icorner}=Xᵢ_{_{—}}ₘₐₓ when the sensitivity sᵢ is negative.

At Step S5, it is determined whether there is an unselected critical path. When there is an unselected critical path, the processing returns to Step S2 to repeat the processes above mentioned until there is no unselected critical path. At Step S6, the report output unit 18 in FIG. 1 outputs the slacks obtained at Step S4 as the timing report 19. The timing report 19 can be expressed in a form easily understood by users, by representing the slacks with an average value Sₐᵥₑ and a standard deviation S_{stddev} thereof, and can be indicated by following Formulas (4), for example.

$${s}_{ave} = {s}_{0} + {\sum }_{i = 1}^{m} {s}_{i} {X}_{icorner} \\ {s}_{stddev} = \sqrt{( {\sum }_{i = m + 1}^{n} {( {s}_{i} {σ}_{i} )}^{2} ) + {( {s}_{n + 1} {R}_{s} )}^{2}} \qquad ( 4 )$$

where σᵢ denotes a standard deviation of the variation factors Xᵢ treated statistically.

As described above, in the first embodiment, the corner conditions in the static timing analysis can be determined by the statistical static timing analysis, and the corner conditions in the static timing analysis can be narrowed down by the single statistical static timing analysis. Accordingly, even when there are many variation factors, the variation factors treated as a range can be considered throughout the range while the increase in the execution time of the timing analysis is suppressed. Therefore, even when the downsizing of the semiconductor integrated circuit is progressed, the timing analysis can be performed accurately.

The flowchart shown in FIG. 3 indicates the method for calculating the slacks of all the critical paths selected by the statistical static timing analysis. However, the slack calculation can be achieved by the sign determination and the simple addition/subtraction and multiplication as indicated by Formula (3), and thus requires a negligibly-short execution time as compared to the statistical static timing analysis performed at Step S1. Therefore, the effect on the entire execution time of the timing analysis is ignorable.

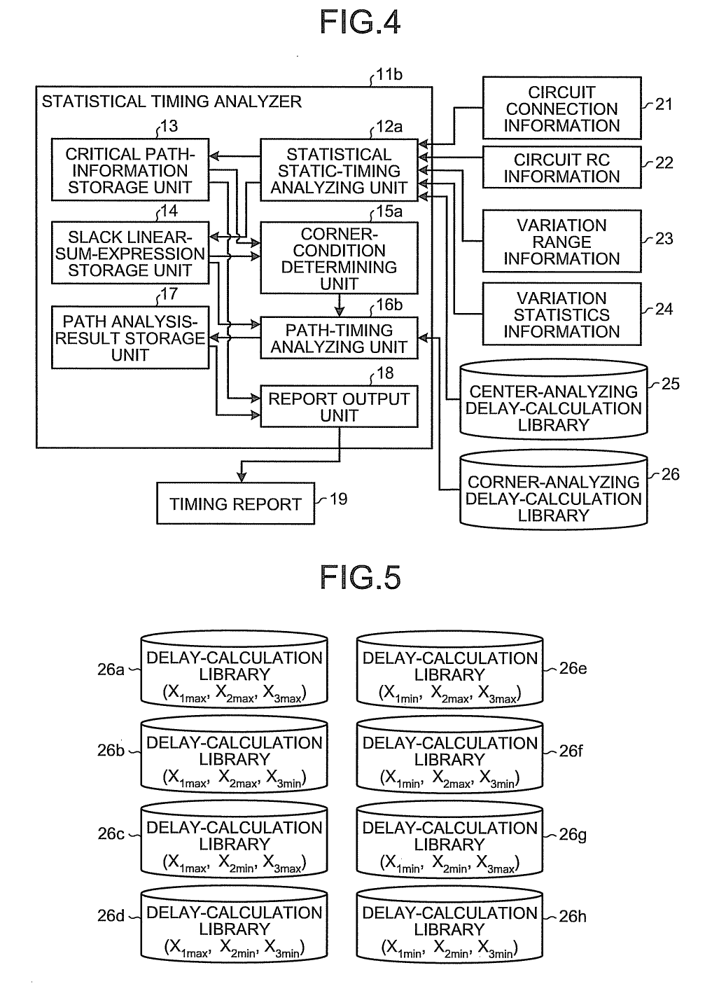

FIG. 4 is a block diagram of a general configuration of a statistical timing analyzer according to a second embodiment of the present invention.

With reference to FIG. 4, a statistical timing analyzer 11b includes a path-timing analyzing unit 16b, instead of the path-timing analyzing unit 16a in FIG. 1. The path-timing analyzing unit 16b can obtain a delay value of an element from a corner-analyzing delay-calculation library 26 while the path-timing analyzing unit 16a in FIG. 1 obtains the delay value of the element from the center-analyzing delay-calculation library 25. The corner-analyzing delay-calculation library 26 is a set of delay calculation libraries including all combinations of best and worst conditions with respect to the variation factors X₁, X₂, . . . , Xₘ treated as a range. For example, when there are three variation factors treated as a range, the corner-analyzing delay-calculation library 26 is a set of delay calculation libraries in eight (=2³) conditions.

FIG. 5 is a block diagram of a specific configuration of the corner-analyzing delay-calculation library 26 shown in FIG. 4.

In FIG. 5, it is assumed that there are three variation factors treated as a range, maximum values of the factors are X₁ₘₐₓ, X₂ₘₐₓ, X₃ₘₐₓ, and minimum values of the factors are X₁ₘᵢₙ, X₂ₘᵢₙ, X₃ₘᵢₙ. In this example, corner-analyzing delay-calculation libraries 26a to 26h in eight conditions, which are all combinations of the minimum and maximum values, can be provided as the corner-analyzing delay-calculation library 26.

For delays d obtained from the corner-analyzing delay-calculation libraries 26a to 26h, it is possible not to regard the variation factors X₁, X₂, . . . , Xₘ treated as a range as the variation. The delay d can be indicated by following Formula (5).

$$d = {d}_{0} + {\sum }_{i = m + 1}^{n} {d}_{i} Δ {X}_{i} + {d}_{i + 1} {R}_{d} \qquad ( 5 )$$

When Formulas (5) and (2) are compared with each other, the variation factors X₁, X₂, . . . , Xₘ treated as a range appear in a delay term of Formula (2), while these variation factors do not appear in a delay term of Formula (5).

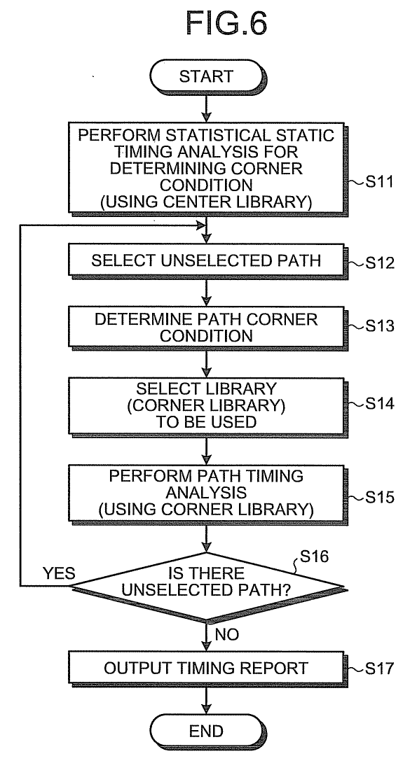

FIG. 6 is a flowchart of a timing analyzing process performed by the statistical timing analyzer shown in FIG. 4.

With reference to FIG. 6, the statistical static-timing analyzing unit 12a in FIG. 4 performs the statistical static timing analysis by referring to the circuit connection information 21, the circuit RC information 22, the variation range information 23, the variation statistics information 24, and the center-analyzing delay-calculation library 25 at Step S11. The statistical static-timing analyzing unit 12a stores resultant information of the critical paths in the critical path-information storage unit 13, and stores the slack linear sum expression indicated by Formula (1) in the slack linear-sum-expression storage unit 14.

The corner-condition determining unit 15a in FIG. 4 then selects one unselected critical path from among the critical paths stored in the critical path-information storage unit 13 at Step S12. The corner-condition determining unit 15a then determines values of ΔX₁, . . . , ΔXₘ in Formula (1) as the corner conditions, based on the slack linear sum expression of the selected critical path at Step S13.

At Step S14, one of the corner-analyzing delay-calculation libraries 26a to 26h is selected based on the corner conditions determined by the corner-condition determining unit 15a. For example, when the corner conditions X₁ₘᵢₙ, X₂ₘₐₓ, and X₃ₘᵢₙ are derived in an environment including three factors X₁, X₂, and X₃ treated as a range, the corner-analyzing delay-calculation library 26f corresponding to the corner conditions X₁ₘᵢₙ, X₂ₘₐₓ, and X₃ₘᵢₙ is selected.

At Step S15, the path-timing analyzing unit 16b in FIG. 4 performs the timing analysis by one of the corner-analyzing delay-calculation libraries 26a to 26h, selected at Step S14, to calculate slacks of the critical path in the corner conditions determined by the corner-condition determining unit 15a. The slack can be indicated by following Formula (6).

$$s = {s}_{0}^{′} + {\sum }_{i = m + 1}^{n} {s}_{i}^{′} Δ {X}_{i} + {s}_{n + 1}^{′} {R}_{d} \qquad ( 6 )$$

where s₀′ denotes a delay average in the corner conditions determined by the corner-condition determining unit 15a, and is different from the average slack s₀ obtained from the center-analyzing delay-calculation library 25. Further, sᵢ′ and sₙ₊₁′ denote slack sensitivity in the corner conditions determined by the corner-condition determining unit 15a. In Formula (6), it is possible to prevent the variation factors X₁, X₂, . . . , Xₘ treated as a range from appearing in the slack term.

It is then determined whether there is an unselected critical path at Step S16. When there is an unselected critical path, the processing returns to Step S12 to repeat the processes above mentioned until there is no unselected critical path. At Step S17, the report output unit 18 in FIG. 4 outputs the slacks obtained at Step S15 as the timing report 19.

As described above, in the second embodiment, the path-timing analyzing unit 16b can calculate the slacks based on the delays corresponding to the corner conditions by the corner-analyzing delay-calculation libraries 26a to 26h as shown in FIG. 5. Accordingly, the analysis accuracy can be increased as compared to the case of using the center-analyzing delay-calculation library 25.

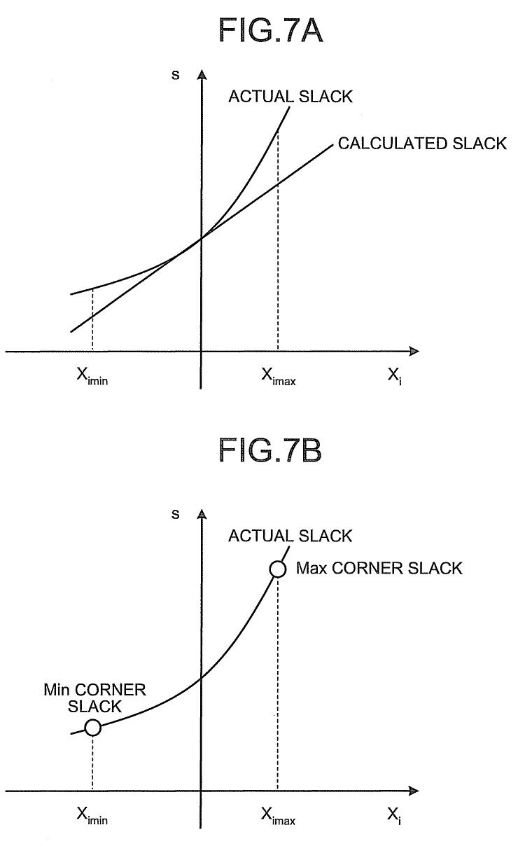

FIG. 7A is a graph of a relation between the slack calculated by the center-analyzing delay-calculation library 25 shown in FIG. 1 and the actual slack. FIG. 7B is a graph of a relation between the slack calculated by the corner-analyzing delay-calculation library 26 shown in FIG. 4 and the actual slack.

In FIG. 7A, because the slack is expressed as the linear sum of the variation factors X₁, X₂, . . . , Xₘ treated as a range, the use of the center-analyzing delay-calculation library 25 shown in FIG. 1 produces a calculation error when the actual delay is not linear with respect to the variation factor Xᵢ treated as a range.

Meanwhile, in FIG. 7B, on the other hand, the use of the corner-analyzing delay-calculation libraries 26a to 26h shown in FIG. 5 enable to calculate the slack based on the delay corresponding to the corner condition. Therefore, no calculation error occurs, and thus a correct calculation result can be obtained.

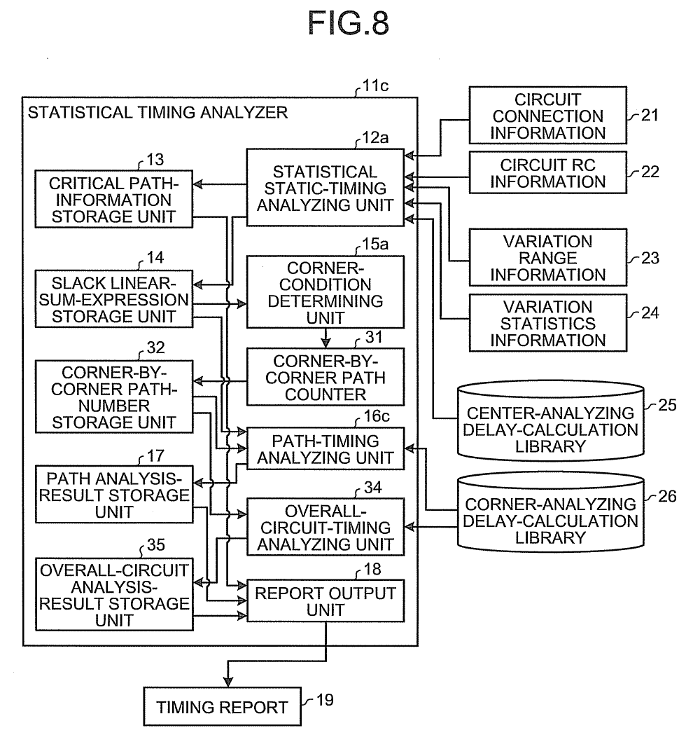

FIG. 8 is a block diagram of a general configuration of a statistical timing analyzer according to a third embodiment of the present invention.

With reference to FIG. 8, a statistical timing analyzer 11c includes a path-timing analyzing unit 16c, instead of the path-timing analyzing unit 16b shown in FIG. 4, and additionally includes a corner-by-corner path counter 31, a corner-by-corner path-number storage unit 32, an overall-circuit-timing analyzing unit 34, and an overall-circuit analysis-result storage unit 35.

The corner-by-corner path counter 31 counts the number of paths in each of the corner conditions determined by the corner-condition determining unit 15a. The corner-by-corner path-number storage unit 32 stores therein the number of paths in each corner condition, counted by the corner-by-corner path counter 31. The overall-circuit-timing analyzing unit 34 performs the timing analysis of the overall circuit to be analyzed. The overall-circuit analysis-result storage unit 35 stores therein a result of the timing analysis performed by the overall-circuit-timing analyzing unit 34.

The statistical static-timing analyzing unit 12a performs the statistical static timing analysis by referring to the circuit connection information 21, the circuit RC information 22, the variation range information 23, the variation statistics information 24, and the center-analyzing delay-calculation library 25, to obtain the critical path of the circuit, and the slack linear sum expression of the critical path. The information of the critical path is stored in the critical path-information storage unit 13, and the slack linear sum expression of the critical path is stored in the slack linear-sum-expression storage unit 14.

The corner-condition determining unit 15a reads the slack linear sum expression of the critical path, obtained by the statistical static-timing analyzing unit 12a, from the slack linear-sum-expression storage unit 14. The corner-condition determining unit 15a determines corner conditions of the critical path, and outputs the corner conditions to the corner-by-corner path counter 31.

When the corner-condition determining unit 15a determines the corner conditions, the corner-by-corner path counter 31 counts the number of paths in each of the corner conditions, and stores the number of paths in the corner-by-corner path-number storage unit 32. The path-timing analyzing unit 16c determines whether the number of paths in the corner condition determined by the corner-condition determining unit 15a is equal to or higher than a threshold. When the number of paths in the corner condition is below the threshold, the path-timing analyzing unit 16c reads the slack linear sum expression of the critical path from the slack linear-sum-expression storage unit 14. The path-timing analyzing unit 16c then performs the static timing analysis with respect to the critical path based on the corner condition outputted from the corner-condition determining unit 15a, by referring to the corner-analyzing delay-calculation library 26, to calculate the slack of the critical path. The path-timing analyzing unit 16c then stores the calculated slack in the path analysis-result storage unit 17.

The overall-circuit-timing analyzing unit 34 determined whether the number of paths in the corner conditions determined by the corner-condition determining unit 15a is equal to or higher than a threshold. When the number of paths in the corner conditions is equal to or higher than the threshold, the overall-circuit-timing analyzing unit 34 performs the static timing analysis of the overall circuit based on the corner conditions outputted from the corner-condition determining unit 15a, by referring to the corner-analyzing delay-calculation library 26, to calculate the slacks of the overall circuit. The overall-circuit-timing analyzing unit 34 then stores the calculated slacks in the overall-circuit analysis-result storage unit 35.

The report output unit 18 reads the information of the critical paths stored in the critical path-information storage unit 13, and the slacks of the critical paths stored in the path analysis-result storage unit 17 or the slacks of the overall circuit stored in the overall-circuit analysis-result storage unit 35, to output the timing report 19. The difference between the overall circuit timing analysis and the path timing analysis is only the analysis time, and the slacks of the critical paths and the slacks of the overall circuit are the same. Accordingly, the same output can be obtained when either the overall circuit timing analysis or the path timing analysis is applied.

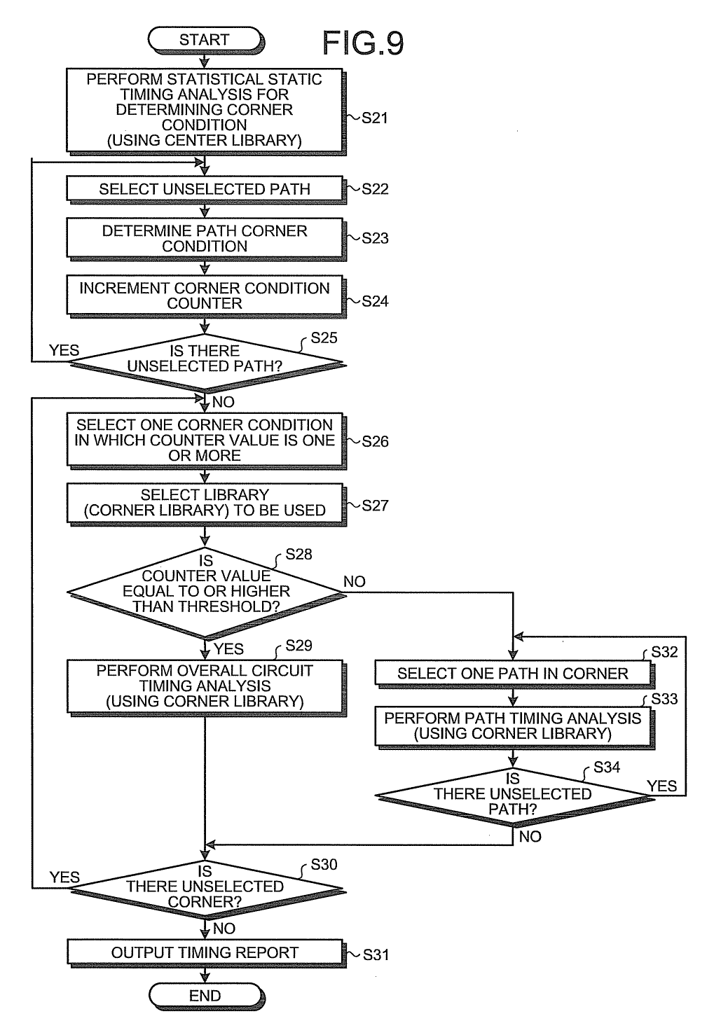

FIG. 9 is a flowchart of a timing analyzing process performed by the statistical timing analyzer shown in FIG. 8.

With reference to FIG. 9, the statistical static-timing analyzing unit 12a shown in FIG. 8 performs the statistical static timing analysis by referring to the circuit connection information 21, the circuit RC information 22, the variation range information 23, the variation statistics information 24, and the center-analyzing delay-calculation library 25 at Step S21. The statistical static-timing analyzing unit 12a stores resultant information of the critical paths in the critical path-information storage unit 13, and the slack linear sum expression indicated by Formula (1) in the slack linear-sum-expression storage unit 14.

The corner-condition determining unit 15a in FIG. 8 then selects one unselected critical path from among the critical paths stored in the critical path-information storage unit 13 at Step S22. The corner-condition determining unit 15a determines values of ΔX₁, . . . , ΔXₘ in Formula (1) as the corner conditions based on the slack linear sum expression of the selected critical path at Step S23.

The corner-by-corner path counter 31 then increments a corner condition counter at Step S24. When it is determined at Step S25 that there is an unselected critical path, the processing returns to Step S22 to repeat the processes above mentioned until there is no unselected critical path.

At Step S26, one corner condition in which the number of paths at each corner, counted by the corner-by-corner path counter 31, is one or more is selected. At Step S27, the corner-analyzing delay-calculation library 26 corresponding to the selected corner condition is selected. At Step S28, it is determined whether the number of paths in the corner condition determined by the corner-condition determining unit 15a is equal to or higher than the threshold. When the number of paths in the corner condition is equal to or higher than the threshold, the overall-circuit-timing analyzing unit 34 performs the static timing analysis of the overall circuit based on the corner condition outputted from the corner-condition determining unit 15a, by referring to the corner-analyzing delay-calculation library 26 at Step S29.

Meanwhile, when the number of paths in the corner condition determined by the corner-condition determining unit 15a is below the threshold, one of the critical paths in the corner condition determined by the corner-condition determining unit 15a is selected at Step S32. The path-timing analyzing unit 16c then performs the static timing analysis with respect to the critical path based on the corner condition selected at Step S32, by referring to the corner-analyzing delay-calculation library 26 at Step S33.

When it is determined at Step S34 that there is an unselected critical path, the processing returns to Step S32, to repeat the processes above mentioned until there is no unselected critical path.

It is then determined at Step S30 whether there is an unselected corner condition. When there is an unselected corner condition, the processing returns to Step S26, to repeat the processes from Step S26 to Step S34 until there is no unselected corner condition. At Step S31, the report output unit 18 in FIG. 8 outputs the slacks obtained at Step S29 or S33 as the timing report 19.

As described above, in the third embodiment, the overall circuit timing analysis and the path timing analysis are selectively used according to the number of paths in each corner. Accordingly, the analysis method for the path timing analysis that requires a shorter execution time can be selected, and thus the entire time required for the timing analysis can be reduced.

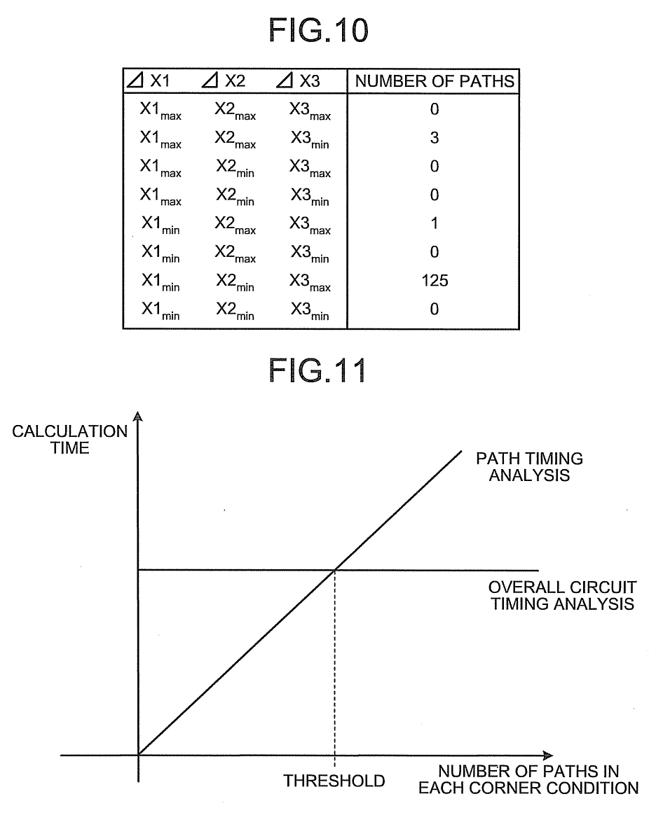

FIG. 10 is an example of the number of paths counted with respect to each corner condition.

In FIG. 10, it is assumed that there are three variation factors treated as a range, and that these factors have the maximum values X₁ₘₐₓ, X₂ₘₐₓ, and X₃ₘₐₓ, and the minimum values X₁ₘᵢₙ, X₂ₘᵢₙ, and X₃ₘᵢₙ, respectively. For example, the number of paths in a corner condition (X₁ₘₐₓ, X₂ₘₐₓ, X₃ₘᵢₙ) counted by the corner-by-corner path counter 31 in FIG. 8 is three, the number of paths in a corner condition (X₁ₘᵢₙ, X₂ₘₐₓ, X₃ₘₐₓ) is one, and the number of paths in a corner condition (X₁ₘᵢₙ, X₂ₘᵢₙ, X₃ₘₐₓ) is 125.

For example, when the threshold used at Step S28 in FIG. 9 is 100, the overall circuit timing analysis at Step S29 is performed in the corner conditions (X₁ₘₐₓ, X₂ₘₐₓ, X₃ₘᵢₙ) and (X₁ₘᵢₙ, X₂ₘₐₓ, X₃ₘₐₓ), and the path timing analysis at Step S33 is performed in the corner condition (X₁ₘᵢₙ, X₂ₘₐₓ, X₃ₘₐₓ).

FIG. 11 is a graph of relations between the number of paths in each corner condition and the calculation times required for the timing analyses.

With reference to FIG. 11, the overall circuit timing analysis requires an almost constant execution time regardless of the number of paths, while the path timing analysis requires an execution time proportional to the number of paths. Accordingly, when the number of paths in each corner condition exceeds the threshold, the execution time of the overall circuit timing analysis becomes shorter than the execution time of the path timing analysis. Therefore, the overall circuit timing analysis is selected to reduce the entire execution time of the timing analysis.

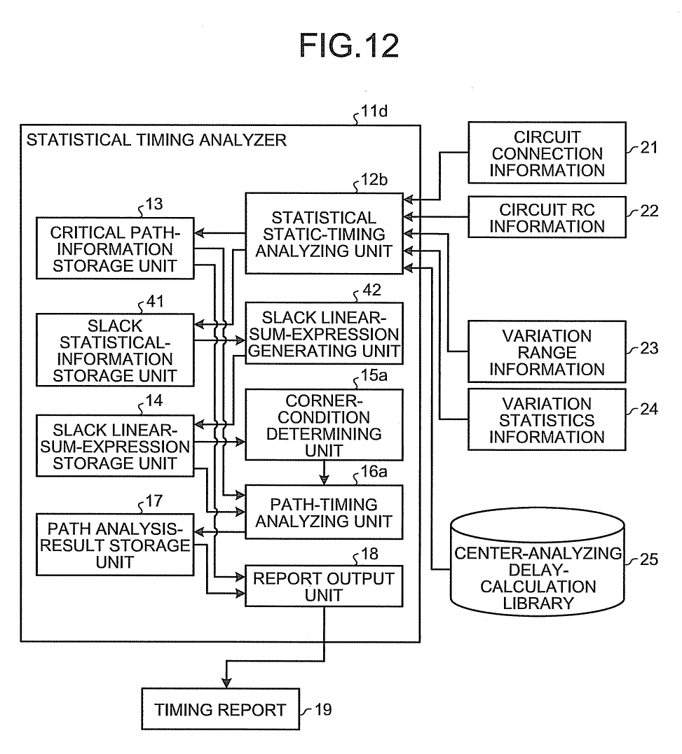

FIG. 12 is a block diagram of a general configuration of a statistical timing analyzer according to a fourth embodiment of the present invention.

With reference to FIG. 12, a statistical timing analyzer 11d includes a statistical static-timing analyzing unit 12b instead of the statistical static-timing analyzing unit 12a in FIG. 1, and additionally includes a slack statistical-information storage unit 41, and a slack linear-sum-expression generating unit 42.

The statistical static-timing analyzing unit 12b calculates slack statistical information as the statistical slack for which n variation factors are statistically considered, based on the statistical static timing analysis of the semiconductor integrated circuit.

The statistical slack s using the slack statistical information can be expressed by following Formula (7).

$$s = {s}_{0} + {\sum }_{i = 1}^{m} {c}_{i} \frac{{σ}_{r}}{{σ}_{i}} Δ {X}_{i} + {\sum }_{i = m + 1}^{n} {c}_{i} \frac{{σ}_{r}}{{σ}_{i}} Δ {X}_{i} + ( \sqrt{1 - {\sum }_{i = 1}^{n} {c}_{i}^{2}} ) {σ}_{r} N ( 0 , 1 ) \qquad ( 7 )$$

where s₀ denotes the average of the slacks, σᵣ denotes a standard deviation of the slacks, σᵢ denotes the standard deviation of the variation factors Xᵢ, cᵢ denotes a correlation coefficient between the variation factor Xᵢ and the slack, and N(0,1) denotes a standard normal distribution in which the average is zero and the standard deviation is one.

The slack statistical-information storage unit 41 stores therein the slack statistical information calculated by the statistical static-timing analyzing unit 12b. The slack statistical-information storage unit 41 can store therein the average s₀ of the slacks, the standard deviation σᵣ of the slacks, and the correlation coefficient cᵢ between the variation factor Xᵢ and the slack, as the slack statistical information. The slack linear-sum-expression generating unit 42 generates the slack linear sum expression from the slack statistical information stored in the slack statistical-information storage unit 41.

When it is assumed that sᵢ and sₙ₊₁ in Formula (1) are indicated by following Formulas (8), the slack statistical information can be converted into the slack linear sum expression.

$${s}_{i} = {c}_{i} \frac{{σ}_{r}}{{σ}_{i}} \\ {s}_{n + 1} = ( \sqrt{1 - {\sum }_{i = 1}^{n} {c}_{i}^{2}} ) {σ}_{r} \qquad ( 8 )$$

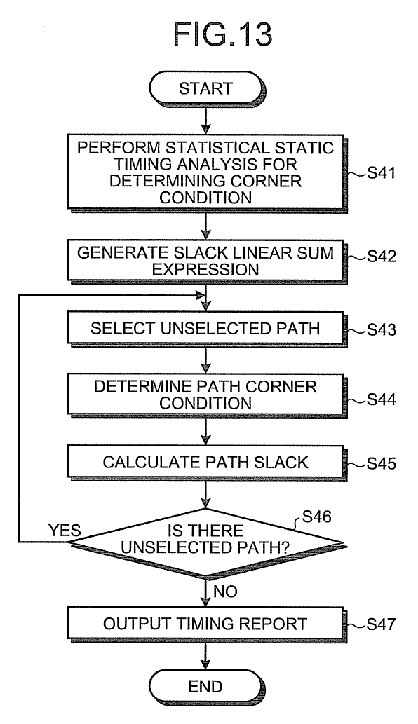

FIG. 13 is a flowchart of a timing analyzing process performed by the statistical timing analyzer shown in FIG. 12.

With reference to FIG. 13, the statistical static-timing analyzing unit 12b shown in FIG. 12 performs the statistical static timing analysis by referring to the circuit connection information 21, the circuit RC information 22, the variation range information 23, the variation statistics information 24, and the center-analyzing delay-calculation library 25, at Step S41. The statistical static-timing analyzing unit 12b stores resultant information of the critical paths in the critical path-information storage unit 13, and the slack statistical information in the slack statistical-information storage unit 41.

The slack linear-sum-expression generating unit 42 then reads the slack statistical information from the slack statistical-information storage unit 41, and assumes sᵢ and sₙ₊₁ in Formula (1) as indicated by Formulas (8) to convert the slack statistical information into the slack linear sum expression, at Step S42. The slack linear-sum-expression generating unit 42 stores the slack linear sum expression in the slack linear-sum-expression storage unit 14.

At Step S43, the corner-condition determining unit 15a in FIG. 12 selects one unselected critical path from among the critical paths stored in the critical path-information storage unit 13. The corner-condition determining unit 15a then determines values of ΔX₁, . . . , ΔXₘ in Formula (1) as the corner conditions, from the slack linear sum expression of the selected critical path, at Step S44.

At Step S45, the path-timing analyzing unit 16a in FIG. 12 calculates the slacks of the critical path in the corner conditions determined by the corner-condition determining unit 15a.

At Step S46, it is determined whether there is an unselected critical path. When there is an unselected critical path, the processing returns to Step S43 to repeat the processes above mentioned until there is no unselected critical path. At Step S47, the report output unit 18 in FIG. 12 outputs the slack obtained at Step S45 as the timing report 19.

As described above, in the fourth embodiment, the slack statistical information can be converted into the slack linear sum expression. Accordingly, even when a commercially available statistical static timing analyzing tool does not have a function of outputting the slack linear sum expression, the timing analysis can be performed accurately while the increase in the execution time of the timing analysis is suppressed.

In the fourth embodiment, the method of calculating the slack by the center-analyzing delay-calculation library 25 is described. However, the slack can be calculated by the corner-analyzing delay-calculation library 26 as shown in FIG. 4. It is also possible to count the number of paths in each corner, and selectively use the overall circuit timing analysis and the path timing analysis according to the number of paths in each corner, as shown in FIG. 8.

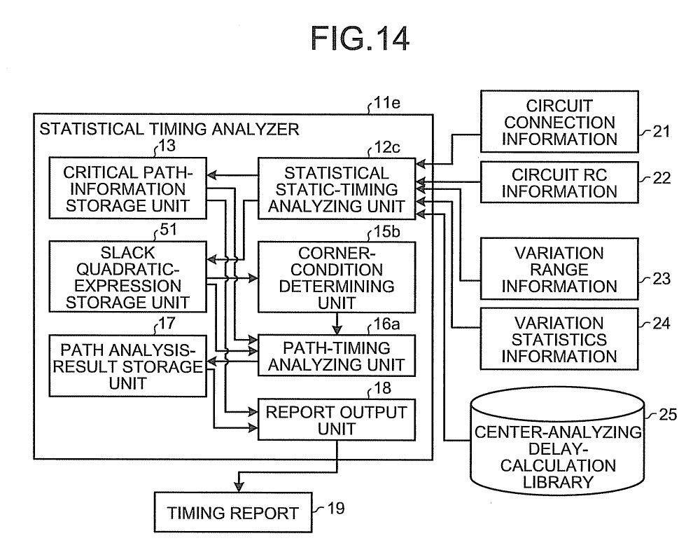

FIG. 14 is a block diagram of a general configuration of a statistical timing analyzer according to a fifth embodiment of the present invention.

With reference to FIG. 14, a statistical timing analyzer lie includes a statistical static-timing analyzing unit 12c instead of the statistical static-timing analyzing unit 12a in FIG. 1, a slack quadratic-expression storage unit 51 instead of the slack linear-sum-expression storage unit 14, and a corner-condition determining unit 15b instead of the corner-condition determining unit 15a.

The statistical static-timing analyzing unit 12c calculates a quadratic equation of slacks as the statistical slack for which the n variation factors are statistically considered, based on the statistical static timing analysis of the semiconductor integrated circuit. The slack quadratic-expression storage unit 51 stores therein the quadratic equation of slacks calculated by the statistical static-timing analyzing unit 12c. The statistical slack s using the quadratic equation of slacks can be indicated by following Formula (9).

$$s = {s}_{0} + {\sum }_{i = 1}^{n} {\sum }_{j = i}^{n} {s}_{ij} Δ {X}_{i} Δ {X}_{j} + {\sum }_{i = 1}^{n} {s}_{i} Δ {X}_{i} + {s}_{n + 1} {R}_{d} \qquad ( 9 )$$

where sᵢⱼ is slack sensitivity to a quadratic term ΔXᵢΔXⱼ of the variation factor. In Formula (9), it is assumed that n=m without considering the variation factors treated statistically.

The corner-condition determining unit 15b determines corner conditions of the critical path based on the quadratic equation of slacks stored in the slack quadratic-expression storage unit 51. For example, the corner-condition determining unit 15b can determine the shift amount ΔXᵢ from the average of the variation factor Xᵢ to minimize the statistical slack s in Formula (9). As a method for determining the corner conditions from the quadratic equation of slacks, a method of solving an optimization problem indicated by following Formulas (10) can be used.

$$\text{Minimize:} {s}_{0} + {\sum }_{i = 1}^{n} {\sum }_{j = i}^{n} {s}_{ij} Δ {X}_{i} Δ {X}_{j} + {\sum }_{i = 1}^{n} {s}_{i} Δ {X}_{i} \\ \text{Constraint:} {X}_{i min} \leq Δ {X}_{i} \leq {X}_{i max} \text{for} ∀ i \qquad ( 10 )$$

The optimization problem indicated by Formulas (10) is a general quadratic programming problem, and can be solved by the Newton's method, or the like.

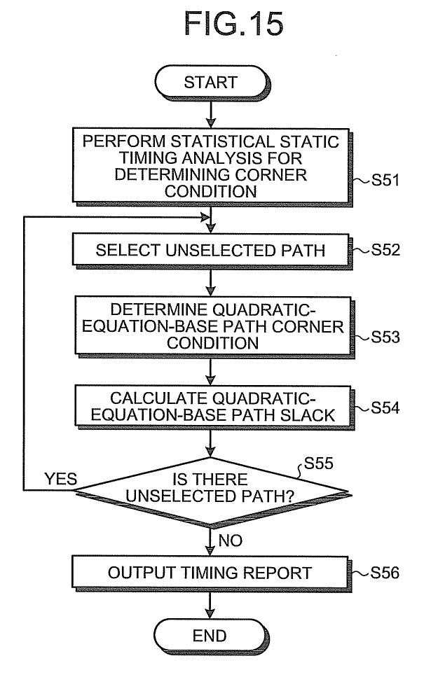

FIG. 15 is a flowchart of a timing analyzing process performed by the statistical timing analyzer shown in FIG. 14.

With reference to FIG. 15, the statistical static-timing analyzing unit 12c in FIG. 14 performs the statistical static timing analysis by referring to the circuit connection information 21, the circuit RC information 22, the variation range information 23, the variation statistics information 24, and the center-analyzing delay-calculation library 25, at Step S51. The statistical static-timing analyzing unit 12c stores resultant information of the critical paths in the critical path-information storage unit 13, and the quadratic equation of slacks indicated by Formula (9) in the slack quadratic-expression storage unit 51.

The corner-condition determining unit 15b in FIG. 14 selects one unselected critical path from among the critical paths stored in the critical path-information storage unit 13, at Step S52. The corner-condition determining unit 15b determines values of ΔX₁, . . . , ΔXₙ in Formula (9) as the corner conditions, based on the quadratic equation of slacks of the selected critical path, at Step S53.

At Step S54, the path-timing analyzing unit 16a in FIG. 14 calculates the slacks of the critical path in the corner conditions determined by the corner-condition determining unit 15b. The calculation of the slacks can be achieved by assigning the shift amount ΔXᵢ from the average of the variation factors Xᵢ, obtained at Step S53, to the quadratic equation of slacks indicated by Formula (9).

At Step S55, it is determined whether there is an unselected critical path. When there is an unselected critical path, the processing returns to Step S52 to repeat the processes above mentioned until there is no unselected critical path. At Step S56, the report output unit 18 in FIG. 14 outputs the slacks obtained at Step S54 as the timing report 19.

As described above, in the fifth embodiment, the statistical slack can be indicated as the quadratic equation of slacks. Accordingly, even when the linearity of the slack is low, the slack can be obtained accurately, and therefore the accuracy in the timing analysis can be increased.

In the fifth embodiment, the method of calculating the slack by the center-analyzing delay-calculation library 25 is described. However, the slack can be calculated by the corner-analyzing delay-calculation library 26 shown in FIG. 4. It is also possible to count the number of paths in each corner, and selectively use the overall circuit timing analysis and the path timing analysis according to the number of paths in each corner, as shown in FIG. 8.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A statistical timing analyzer comprising:
a statistical static-timing analyzing unit that performs a statistical static timing analysis of a semiconductor integrated circuit;
a corner-condition determining unit that determines corner conditions of the semiconductor integrated circuit based on a result of the statistical static timing analysis; and
a path-timing analyzing unit that performs a static timing analysis of the semiconductor integrated circuit based on the corner conditions.

2. The statistical timing analyzer according to claim 1, wherein the statistical static-timing analyzing unit outputs a critical path of the semiconductor integrated circuit, and a statistical slack of the critical path for which n (n is an integer equal to or larger than 2) variation factors are statistically considered.

3. The statistical timing analyzer according to claim 2, wherein the statistical slack is expressed as a linear sum of slacks.

4. The statistical timing analyzer according to claim 3, wherein the corner-condition determining unit determines the corner conditions of the critical path based on the statistical slack expressed as the linear sum of slacks.

5. The statistical timing analyzer according to claim 2, wherein the statistical slack is expressed as a slack statistical-information.

6. The statistical timing analyzer according to claim 5, further including a slack linear-sum-expression generating unit that generates slack linear sum information from the slack statistical information.

7. The statistical timing analyzer according to claim 2, wherein the statistical slack is expressed as a quadratic equation of slacks.

8. The statistical timing analyzer according to claim 7, wherein the corner-condition determining unit determines the corner conditions of the critical path based on the statistical slack expressed as the quadratic equation of slacks.

9. The statistical timing analyzer according to claim 2, wherein the statistical slack includes a portion of an average of slacks, a portion corresponding to a variation factor treated as a range, and a portion of sensitivity to the variation factor treated as a range.

10. The statistical timing analyzer according to claim 9, wherein the corner-condition determining unit determines a shift amount of the variation factor treated as a range, as the corner condition, to minimize the statistical slack.

11. The statistical timing analyzer according to claim 10, wherein the corner-condition determining unit determines the corner condition based on a sign of a coefficient of the portion of the sensitivity to the variation factor treated as a range.

12. The statistical timing analyzer according to claim 11, wherein the corner-condition determining unit determines a minimum value in the range of the variation factor as the shift amount when the slack sensitivity to the variation factor is positive, and determines a maximum value in the range of the variation factor as the shift amount when the slack sensitivity to the variation factor is negative.

13. The statistical timing analyzer according to claim 2, further including a center-analyzing delay-calculation library that is used in the statistical static timing analysis to calculate a delay of an element, wherein
the path-timing analyzing unit obtains the delay of the element based on the center-analyzing delay-calculation library.

14. The statistical timing analyzer according to claim 13, wherein the delay obtained based on the center-analyzing delay-calculation library includes a delay term resulting from the variation factor treated as a range, and a delay term resulting from the variation factor treated statistically.

15. The statistical timing analyzer according to claim 2, further including a corner-analyzing delay-calculation library that is a set of delay calculation libraries as all combinations of best and worst conditions with respect to a variation factor treated as a range, wherein
the path-timing analyzing unit obtains a delay of an element based on the corner-analyzing delay-calculation library.

16. The statistical timing analyzer according to claim 15, wherein the delay obtained based on the corner-analyzing delay-calculation library includes a delay term resulting from a variation factor treated statistically, and includes no delay term resulting from the variation factor treated as a range.

17. The statistical timing analyzer according to claim 2, further including:
a corner-by-corner path counter that counts the number of paths in each of the corner conditions determined by the corner-condition determining unit; and
an overall-circuit-timing analyzing unit that performs a timing analysis of the overall semiconductor integrated circuit when the number of paths in the corner condition determined by the corner-condition determining unit is equal to or higher than a threshold.

18. A statistical timing analysis method comprising:
calculating a statistical slack for which n (n is an integer equal to or larger than 2) variation factors are statistically considered, based on a statistical static timing analysis of a semiconductor integrated circuit;
determining corner conditions of the semiconductor integrated circuit based on the statistical slack; and
calculating slacks of the semiconductor integrated circuit based on a static timing analysis in the corner conditions.

19. A statistical timing analysis method comprising:
calculating a statistical slack for which n (n is an integer equal to or larger than 2) variation factors are statistically considered, based on a statistical static timing analysis of a semiconductor integrated circuit;
selecting critical paths of the semiconductor integrated circuit based on the statistical slack;
determining corner conditions of the critical paths based on the statistical slack; and
calculating slacks of the semiconductor integrated circuit based on a static timing analysis in the corner conditions.

20. The statistical timing analysis method according to claim 19, further including:
counting the number of critical paths in each of the corner conditions;
selecting one of the corner conditions in which the overall semiconductor integrated circuit is to be analyzed, based on the number of critical paths;
calculating a slack of the overall semiconductor integrated circuit based on the corner condition in which the overall semiconductor integrated circuit is to be analyzed;
selecting one of the corner conditions to be analyzed for each path in the semiconductor integrated circuit, based on the number of critical paths; and
calculating a slack of each path in the semiconductor integrated circuit based on the corner condition to be analyzed for each path in the semiconductor integrated circuit.
